(19) United States
(12) Patent Application Publication
(10) Pub. No.: US 2022/0138799 A1
(43) Pub. Date: May 5, 2022

(54) STREAMLESS CONTENT AWARE AD INSERTION

(71) Applicants: Bryce Brown, Saint Petersburg, FL (US); Kirstin Wright Brown, Saint Petersburg, FL (US)

(72) Inventors: Bryce Brown, Saint Petersburg, FL (US); Kirstin Wright Brown, Saint Petersburg, FL (US)

(21) Appl. No.: 17/090,877

(22) Filed: Nov. 5, 2020

(51) Int. Cl. G06Q 30/02; H04L 29/08; G06Q 50/00; G06F 16/2455; G06F 16/953

(52) U.S. Cl. CPC G06Q 30/0255; H04L 67/02; G06Q 30/0269; G06F 16/953; G06Q 50/01; G06F 16/24568; G06Q 30/0277

(57) ABSTRACT

A system and method for providing online customized advertisements, and more specifically, A system and method for providing content-aware ad insertion into streaming data using a web server. The web server has a memory having instructions stored thereon, and a processor configured to execute the instructions on the memory to cause the web server to perform operations. The web server transmit streaming data from the content creator computer to the web server, parse the streaming data to identify keywords within the streaming data, when the identified keywords are known in a database of keywords associated with available advertisements, select the available advertisements corresponding to the identified keywords, when the identified keywords are unknown in a database of keywords associated with available advertisements, select generic advertisements, insert the selected advertisements into the streaming data, and rebroadcast the modified streaming data to the content consumer computers.

### TECHNICAL FIELD

This application relates in general to a system and method for providing online customized advertisements, and more specifically, to a system and method for providing content aware ad insertion into streaming data.

### BACKGROUND

There are many sources of live content that exist today. This can be anything from a live sports game to someone streaming video games from their computer at home to someone walking around downtown interacting with people in their chat. The problem is that this live content is often paired with pre-chosen, non-relevant advertisement content that is ignored by the people watching the live content.

Therefore, a need exists for a system and method for providing content-aware ad insertion into streaming data; a system that analyzes stream content in real time (both audio and video) and serves a relevant advertisement based on the real-time information. Take, for instance, someone streaming video games and they suddenly get a craving for a taco. They mention this, and Streamless seamlessly serves an advertisement for tacos based on the aforementioned keyword.

### SUMMARY

In accordance with the present invention, the above and other problems are solved by providing a system and method for providing content-aware ad insertion into streaming data according to the principles and example embodiments disclosed herein.

In one embodiment, the present invention is a system providing content-aware ad insertion into streaming data. A system provides content-aware ad insertion into streaming data using a web server. The web server has a memory having instructions stored thereon, and a processor configured to execute the instructions on the memory to cause the web server to perform operations. The web server transmits streaming data from the content creator computer to the web server, parses the streaming data to identify keywords within the streaming data, when the identified keywords are known in a database of keywords associated with available advertisements, selects the available advertisements corresponding to the identified keywords, when the identified keywords are unknown in a database of keywords associated with available advertisements, selects generic advertisements, inserts the selected advertisements into the streaming data, and rebroadcasts the modified streaming data to the content consumer computers.

In another embodiment, the present invention is a method providing content-aware ad insertion into streaming data. The method provides content-aware ad insertion into streaming data using a web server. The method transmits streaming data from the content creator computer to the web server, parses the streaming data to identify keywords within the streaming data, when the identified keywords are known in a database of keywords associated with available advertisements, selects the available advertisements corresponding to the identified keywords, when the identified keywords are unknown in a database of keywords associated with available advertisements, selects generic advertisements, inserts the selected advertisements into the streaming data, and rebroadcasts the modified streaming data to the content consumer computers.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of a system that provides content-aware ad insertion into streaming data according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIG. 3 illustrates another example embodiment of a system providing content-aware ad insertion into streaming data according to the present invention.

FIG. 4 illustrates a computing system of software components providing content-aware ad insertion into streaming data according to the present invention.

FIG. 5 illustrates a flowchart corresponding to a method performed by software components providing content aware ad insertion into streaming data according to the present invention.

### DETAILED DESCRIPTION

This application relates in general to a system and method for providing streaming advertisements, and more specifically, to a system and method for providing content-aware ad insertion into streaming data according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly,” consistent with the discussion above regarding ranges and numerical data.

The term “mobile application” refers to an application executing on a mobile device such as a smartphone, tablet, and/or web browser on any computing device.

The term “content creators” refers to individuals generating and sharing streaming media content including playing video games, interactive question and answer session, live sporting events, and similar live events.

The terms “customer” and “user” refer to an entity, e.g. a human, using the content-aware ad insertion into streaming data system including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), ethernet cable(s) or wireless connection(s) using any type of frequency/frequencies or radio wave(s). Some examples are included below in this application.

The term “ad” or “ads” refer to images, video and audio content, and similar material that provides advertisements for a sponsor of the content creator and/or the web platform. The term “ad” and “advertisement” may be used interchangeably.

The term “invention” or “present invention” refers to the invention being applied for via the patent application with the title “STREAMLESS—CONTENT-AWARE AD INSERTION.” Invention may be used interchangeably with streaming system and Streamless.

The terms “communicate”, or “communication” refer to any component(s) connecting with any other component(s) in any combination for the purpose of the connected components to communicate and/or transfer data to and from any components and/or control any settings.

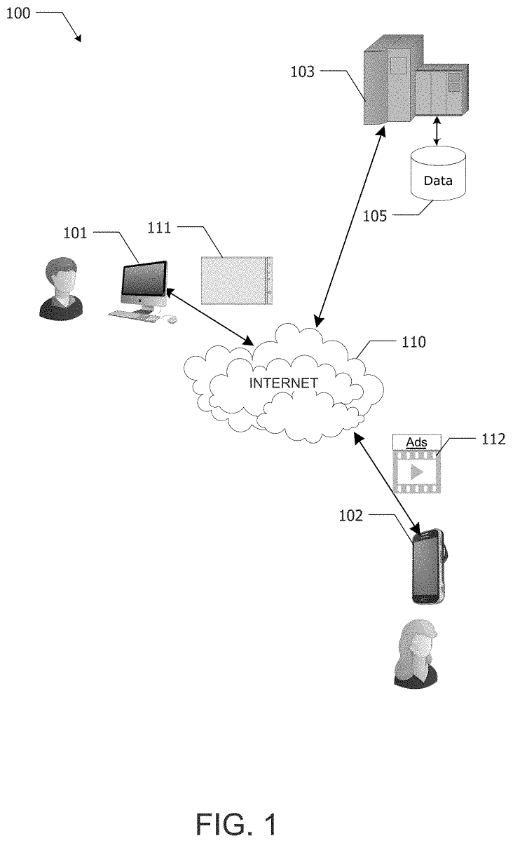

In general, the present disclosure relates to a system and method for providing streaming data advertisements. To better understand the present invention, FIG. 1 illustrates an example embodiment for a system 100 providing content-aware ad insertion into streaming data according to the present invention. The system 100 comprises a content creator 101 creating streaming video content 111 that is transmitted over the Internet 110 to an ad server 103. The ad server 103 processes the streaming content 111 to find dynamically recognized content-aware topics, which may be considered content keywords. The ad server 103 searches an internal database of available advertisements 105 for relevant ads related to the content keywords.

The ad server 103 uses a set of search results from the database search to select one or more ads to be included with the streaming content 111 when ad-supported streaming content 112 is sent to a consumer 102 for viewing. The content creator 101 and the content consumer 102 typically utilize programmable computing devices to perform their respective tasks. These programmable computing devices may include portable devices such as smartphones and tablets as well as more general purpose devices such as laptop and desktop personal computers. These devices 102 must include an ability to run a mobile application supporting the present invention, a display and user interface to interact with the users and to view the streaming content, and an ability to communicate over the Internet 110.

The ad server 103 typically is a web-based server 103 that is accessible from remote user devices. The ad server will support a number of different streaming content data streams simultaneously while providing each of the different streaming content data streams to one or more content consumers while the content data stream is being broadcast. The content creators 101 may include a variety of different types of content data streams, for example, the content data streams may comprise a movie and video producers data, a live streaming video gaming sessions, an individual live video chat and related broadcast, and any other user-created video content producible on a programmable computing device such as mobile device.

The invention may use any type of network such as a single network, multiple networks of a same type, or multiple networks of different types which may include one or more of a direct connection between devices, including but not limited to a local area network (LAN), a wide area network (WAN) (for example, the Internet), a metropolitan area network (MAN), a wireless network (for example, a general packet radio service (GPRS) network), a long term evolution (LTE) network, a telephone network (for example, a Public Switched Telephone Network or a cellular network), a subset of the Internet, an ad hoc network, a fiber optic network (for example, a fiber optic service (often known as FiOS) network), or any combination of the above networks.

Smart devices mentioned herein the present application may also use one or more sensors to receive or send signals, such as wireless signals for example, Bluetooth™, wireless fidelity, infrared, Wi-Fi, or LTE. Any smart device mentioned in this application may be connected to any other component or smart device via wired communications (e.g., conductive wire, coaxial cable, fiber optic cable, ethernet cable, twisted pair cable, transmission line, waveguide, etc.), or a combination of wired and wireless communications. The invention's method and/or system may use a single server device or a collection of multiple server devices and/or computer systems.

The systems and methods described above, may be implemented in many different forms of applications, software, firmware, and hardware. The actual software or smart device application codes or specialized control software, hardware or smart device application(s) used to implement the invention's systems and methods is not limiting of the implementation. Thus, the operation and behavior of the systems and methods were described without reference to the specific software or firmware code. Software, smart device application(s), firmware, and control hardware can be designed to implement the systems and methods based on the description herein.

While all of the above functions are described to be provided to users via a mobile application on a smartphone, one of ordinary skill will recognize that any computing device including tablets, laptops, and general purpose computing devices may be used as well. In at least one embodiment, all of the services described herein are provided using web pages being accessed from the web server 103 using a web browser such as Safari™, Firefox™, Chrome™ DuckDuckGo™, and the like. All of the screen examples described herein show user interface elements that provide the functionality of the present invention. The arrangement, organization, presentation, and use of particular user input/output (I/O) elements including hyperlinks, buttons, text fields, scrolling lists, and similar I/O elements are shown herein for example embodiments only to more easily convey the features of the present invention. The scope of the present invention should not be interpreted as being limited by any of these elements unless expressly recited within the attached claims.

For the purposes of the example embodiment of FIG. 1, various functions are shown to be performed on different programmable computing devices that communicate with each other over the Internet 110. These computing devices may include smartphones 102, laptop computers 101, tablets (not shown), and similar devices so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspect or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

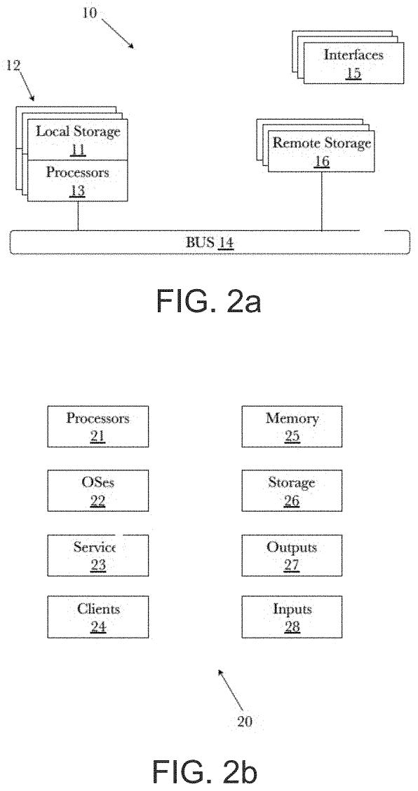

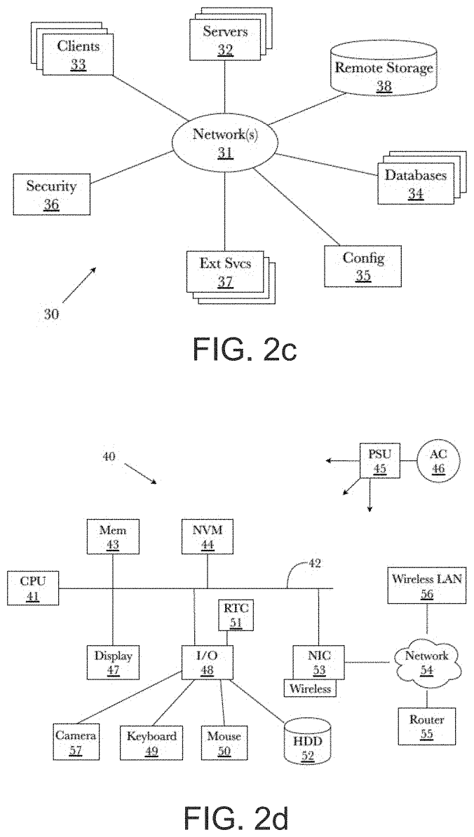

Referring now to FIG. 2a, there is a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network, a metropolitan area network, a local area network, a wireless network, the Internet or any other network, using known protocols for such communication, whether wireless or wired.

In one aspect, computing device 10 includes one or more central processing units (CPU) 12, one or more interfaces 15, and one or more buses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may be caused to perform one or more of the different types of functions and/or operations under the control of software modules or components, which for example, may include an operating system and any appropriate applications software, drivers, and the like.

A CPU 12 may include one or more processors 13 such as for example, a processor from one of the Intel, ARM, Qualcomm, and AMD families of microprocessors. In some aspect, processors 13 may include specially designed hardware such as application-specific integrated circuits (ASICs), electrically erasable programmable read-only memories (EEPROMs), field-programmable gate arrays (FPGAs), and so forth, for controlling operations of a computing device 10. In a particular aspect, a local memory 11 (such as non-volatile random access memory (RAM) and/or read-only memory (ROM), including for example, one or more levels of cached memory) may also form part of a CPU 12. However, there are many different ways in which memory may be coupled to a system 10. Memory 11 may be used for a variety of purposes such as, for example, caching and/or storing data, programming instructions, and the like. It should be further appreciated that a CPU 12 may be one of a variety of system-on-a-chip-(SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may, for example, support other peripherals used with a computing device 10. Among the interfaces that may be provided are ethernet interfaces, frame relay interfaces, cable interfaces, DSL interfaces, token ring interfaces, graphics interfaces, and the like. In addition, various types of interfaces may be provided such as, for example, universal serial bus (USB), serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast ethernet interfaces, gigabit ethernet interfaces, serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), point of sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (for example, remote memory block 16 and local memory 11) configured to store data, program instructions for the general-purpose network operations or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information or any other specific or generic non-program information described herein.

Because such information and program instructions may be employed to implement one or more systems or methods described herein, at least some network device aspects may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “hot-swappable” hard disk drives or solid state drives, removable optical storage disks, or other such removable media, and that such integral and removable storage media may be utilized interchangeably. Examples of program instructions include both object code, such as may be produced by a compiler, machine code, such as may be produced by an assembler or a linker, byte code, such as may be generated by for example by a JAVA™ compiler and may be executed using a JAVA™ virtual machine or equivalent, or files containing higher level code that may be executed by the computer using an interpreter (for example, scripts written in Python™, Perl™, Ruby™, Groovy™, or any other scripting language).

In some aspects, systems may be implemented on a standalone computing system. Referring now to FIG. 2b, there is a block diagram depicting a typical exemplary architecture of one or more aspects or components thereof on a standalone computing system. A computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the LINUX™ operating system, ANDROID™ operating system, or the like. In many cases, one or more shared services 23 may be operable in system 20, and may be useful for providing common services to client applications 24. Services 23 may, for example, be WINDOWS™ services, user-space common services in a LINUX™ environment or any other type of common service architecture used with an operating system 22. Input devices 28 may be of any type suitable for receiving user input including, for example, a keyboard, touchscreen, microphone (for example, for voice input), mouse, touchpad, trackball or any combination thereof. Output devices 27 may be of any type suitable for providing output to one or more users, whether remote or local to system 20, and may include, for example, one or more screens for visual output, speakers, printers or any combination thereof. Memory 25 may be RAM having any structure and architecture known in the art for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, CD-ROM, and the like.

In some aspects, systems may be implemented on a distributed computing network, such as one having any number of clients and/or servers. Referring now to FIG. 2c, there is a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 2b. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, LTE, and so forth) or local area network (or indeed any network topology known in the art; the aspect does not prefer any one network topology over another). Networks 31 may be implemented using any known network protocols, including, for example, wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored on a server system 32 in the Cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to bus 42, to which bus is also connected to memory 43, nonvolatile memory 44, display 47, I/O unit 48, and network interface card (NIC) 53. An I/O unit 48 may, typically, be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

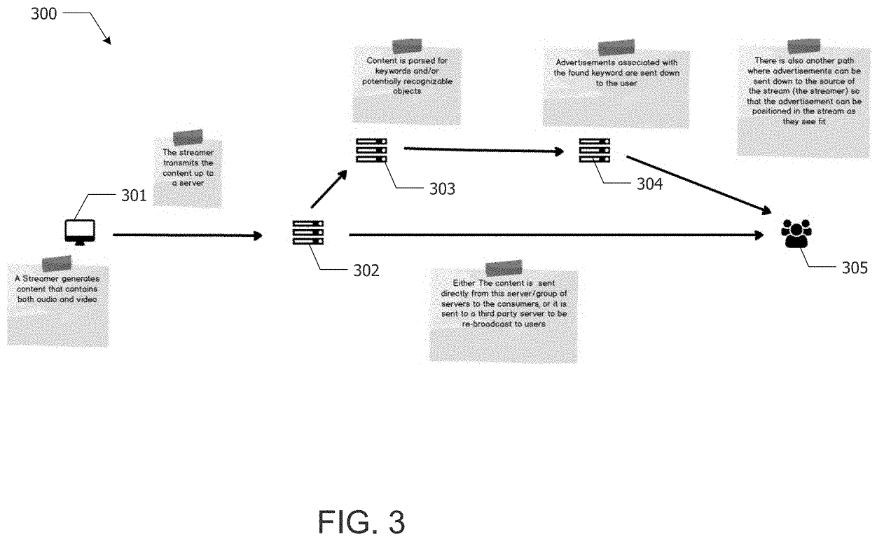

FIG. 3 illustrates another example embodiment of a system providing content-aware ad insertion into streaming data according to the present invention. As described above with respect to FIG. 1, FIG. 3 shows a content creator 301 creating and sending a streaming content data stream to one or more content consumers 305 as well as the ad server 103 of FIG. 1. The ad server 103 processes the streaming content data stream 302, which is duplicated with one version processed into its respective audio and video components 303. These audio and video components are processed to identify one or more content keywords based upon the analysis of the streaming content data stream's audio and video components. One or more relevant advertisements are selected from an available ad database 304 based upon how well the selected advertisements match the content keywords. These selected advertisements are then sent to the content consumer 305 for viewing along with the streaming content data stream from the content generator 301. A second version of the content data stream 302 may also be sent directly to the content consumers 305.

The content is sent as a stream to a broadcasting server (or typically a cloud as many web servers 103 may be involved). The web server 103 then rebroadcasts the content to users that are consuming the stream. This rebroadcasting takes the massive load for streaming video content off of the content creators machine 101. The web server 103 may consume the stream in order to determine the applicable advertisement. If the content generator 101 is streaming through the web server 103, the server may then send a copy of the stream to a dedicated system/server/cloud that will parse the audio/video. If the end stream is meant to be shown on a third party program, the web server 103 can have the streamer set up the web server 103 as a proxy, where the web server 103 copies and parses the stream before rebroadcasting it to the desired platform.

Also, for placing advertisements within streams on third party platforms (i.e.

Twitch), the system 100 gives the content generator 101 control of where the content is shown within the data stream, where once a relevant term/trigger is detected by the web server 103, the system 100 would then send down the advertisement, typically a banner-ad image, to the content creator 101 to be rebroadcast.

The selected advertisements may be inserted into the streaming content data stream as seen by the content consumer 305 as banner and sidebar advertisements surrounding the streaming content data stream of the content generator 301. While the example of FIG. 3 shows the combining of the selected advertisements with the streaming content data stream occurring in the computing device of the content consumer 305, as described in FIG. 1, the streaming content data stream and the selected ads may be combined into the ad-supported streaming content data stream 112 in the ad server 103 with the combination of content being forwarded to the content consumer 305.

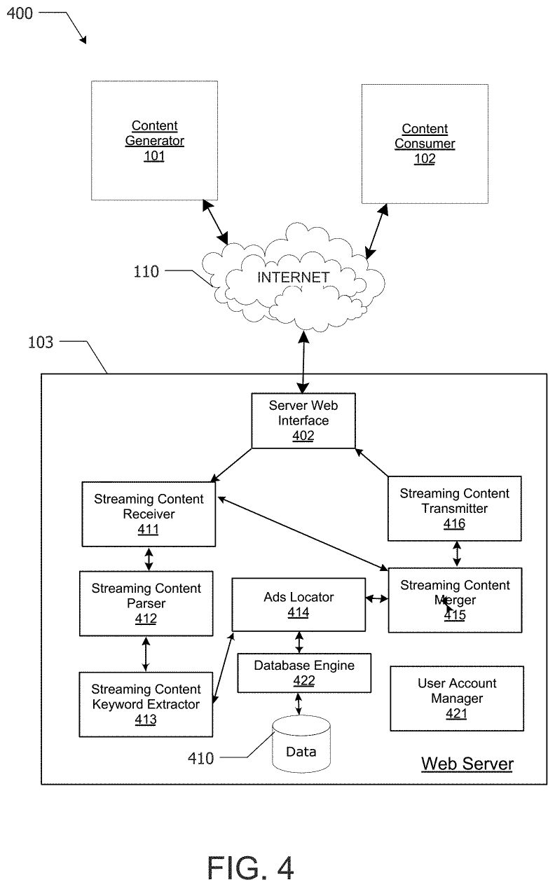

FIG. 4 illustrates a computing system of software components providing content-aware ad insertion into streaming data according to the present invention. The system comprises a content generator 101 and a content consumer 102 using a programmable computing device connected to the Internet 110 to transmit and receive streaming content data streams. The streaming content 111 is first processed by the ad server 103 to create ad-supported streaming content 112 before it is sent to the content consumer 102.

The ad server comprises a set of processing components to perform the streaming content analysis, ad selection, and ad insertion processing. This set of processing components comprises a server web interface 402, a streaming content receiver 411, a streaming content parser 412, a streaming content keyword extractor 413, an ad locator 414, a streaming content merger 415, and a streaming content transmitter 416. The ad server 103 may also include a user account manager 421 to manage content generators 101 and content consumers' 102 access to the streaming content processed by the ad server 103 and a database engine 422 to provide access to a database of available advertisements for insertion into streaming data streams.

The server web interface 402 permits the ad server 103 to communicate with remote users computing devices 101 and mobile devices 102. The web interface 402 performs all of the data formatting, computer to computer communications, encryption processing, and all similar operations needed by the web server to communicate with users.

The streaming content receiver 411 establishes a connection with the content creator 101 and accepts the streaming content data stream 111. The streaming content receiver 411 manages the establishment and termination of the connection with the content generator 101 as well as controls the packet data flow and error correction within the streaming content data stream. The streaming content receiver 411 also may enforce data encryption and decryption of the streaming content data stream with possible assistance of the server web interface 402.

The streaming content parser 412 receives the streaming content data stream from the streaming content receiver 411 and parses it into its respective audio and video components. The streaming content parser 412 also may perform initial analysis of the audio and video components to perform facial and object recognition and speech to text processing on these data components.

The streaming content keyword extractor 413 receives the data generated by the streaming content parser 412 to identify all relevant content keywords from the streaming content data stream. These content keywords may be related to locations of scenes in the video data, identities of individuals in the video and audio data, item references in the dialog detected in the audio data, and similar factors. The content keywords may be ranked according to an individual user profile associated with the content consumer 102 such as view demographics, known interests from past video sessions, and other available online information associated with the content consumer 102 to match the interests of the consumer.

The ad locator 414 obtains the content keywords and any keyword ranking from the streaming content keyword extractor 413 and searches the available advertisement database 410 for individualized advertisements of possible interest to the content consumer 102 to dynamically select advertisements for insertion into the streaming content data stream presented to the content consumer 102. The individualized advertisements are selected based upon real time processing of the content being viewed rather than static user profiles, demographics, and similar factors. The individualized advertisements are more likely to be of interest to individual consuming the content.

The streaming content merger 415 receives the selected advertisements from the ad locator 414 and along with the streaming content data stream form the streaming content receiver 411 for merging into the content aware streaming content data stream 112. Additionally, content creators may determine where the ad is displayed within their content on a third party platform.

As discussed above, FIG. 4 shows the merger of these two data sources is disclosed to occur on the ad server 103 with the combined content then sent to the content consumer 102. As noted above, this functionality also may be located in the computing device of the content consumer 102. Additionally, content creators may insert individualized ads as disclosed herein into content from third party content sources when the inserted ads are to be included within a banner ad displayed along with the content.

Additionally, the selected advertisements provided to the streaming content merger 415 may comprise an ad description used in the selection process and a web link URL to the advertisement content to be viewed by the content consumer 102. The web link URL may be used to permit the content consumer 102 to retrieve the advertisement as web content for presentation as part of the content shown to the content consumer 102. The web link URL also may be used by the streaming content merger 415 to obtain the advertisement content for insertion into the streaming content data stream before being sent to the content consumer 102. The location of this data merger may be dictated by the number of simultaneously watching content consumers 102 and the available communications bandwidth to the content consumers 102.

The streaming content transmitter 416 establishes a connection with the content consumer 102 and sends the ad-supported streaming content data stream 112. The streaming content transmitter 416 manages the establishment and termination of the connection with the content consumer 102 as well as controls the packet data flow and error correction within the streaming content data stream. The streaming content transmitter 416 also may enforce data encryption and decryption of the streaming content data stream with possible assistance of the server web interface 402.

The database engine 422 processes all database operations for the available advertisement database 410. These operations include searching and retrieving available advertisements based upon content keywords from the database 410 and indexing the database 410 to maintain efficient searching when needed.

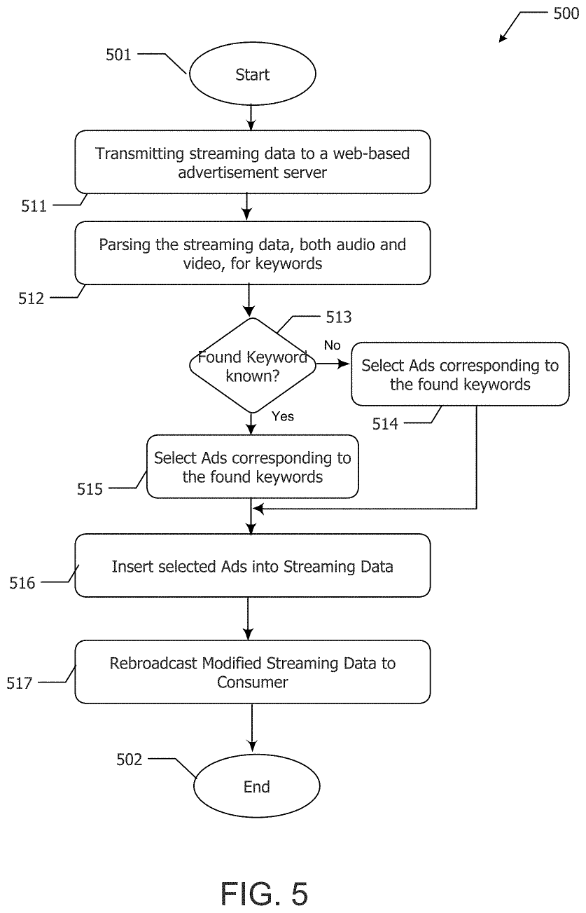

FIG. 5 illustrates a flowchart corresponding to a method performed by software components providing content-aware ad insertion into streaming data according to the present invention. The process 500 begins 501 when a content generating computer transmits streaming data to a web server in step 511. The web server, in step 512, parses the streaming data to identify known keywords found within a database of known keywords and corresponding advertisements. Test step 513 determines whether any of the keywords found in parsing the streaming data match known keywords in the database.

In step 514, the web server selects generic advertisements when none of the keywords found in parsing the streaming data match known keywords in the database. In step 515, the web server selects advertisements from the database having corresponding known keywords that match the keywords found in parsing the streaming data. The web server inserts the selected advertisement into the streaming data in step 516. The web server rebroadcasts the streaming data to the content consuming computers in step 517 before the process ends 502.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise. Any singular term used in this present patent application is applicable to its plural form even if the singular form of any term is used.

In the present application, all or any part of the invention's software or application(s) or smart device application(s) may be installed on any of the user's or operator's smart device(s), any server(s) or computer system(s) or web application(s) required to allow communication, control (including but not limited to control of parameters, settings such as for example, sign copy brightness, contrast, ambient light sensor settings . . . etc.), transfer of content(s) or data between any combination of the component.

What is claimed is:

1. A system for providing content-aware ad insertion into streaming data using a web server connected to the Internet, the Internet communicatively interconnects the web server, a content creator computer, and a content consumer computer, the web server comprises:
a memory having instructions stored thereon; and
a processor configured to execute the instructions on the memory to cause the electronic apparatus to:
receive streaming data from the content creator computer to the web server;
parse the streaming data to identify keywords within the streaming data;
when the identified keywords are known in a database of keywords associated with available advertisements, select the available advertisements corresponding to the identified keywords;
when the identified keywords are unknown in a database of keywords associated with available advertisements, select generic advertisements;
insert the selected advertisements into the streaming data; and
rebroadcast the modified streaming data to the content consumer computers.

2. The web server according to claim 1, parsing the streaming data comprises parsing the audio portion of the streaming data and the video portion of the streaming data to identify known keywords.

3. The web server according to claim 1, wherein rebroadcasting the modified streaming data has the web server acting as a proxy server for the content creator computer.

4. The web server according to claim 1, where the selected advertisements are banner ads shown above and below streaming data content.

5. A method for providing content-aware ad insertion into streaming data using a web server connected to the Internet, the Internet communicatively interconnects the web server, a content creator computer, and a content consumer computer, the method comprising:
receiving streaming data from the content creator computer to the web server;
parsing the streaming data to identify keywords within the streaming data;
when the identified keywords are known in a database of keywords associated with available advertisements, selecting the available advertisements corresponding to the identified keywords;
when the identified keywords are unknown in a database of keywords associated with available advertisements, selecting generic advertisements;
inserting the selected advertisements into the streaming data; and
rebroadcasting the modified streaming data to the content consumer computers.

6. The method according to claim 5, parsing the streaming data comprises parsing the audio portion of the streaming data and the video portion of the streaming data to identify known keywords.

7. The method according to claim 5, wherein rebroadcasting the modified streaming data has the web server acting as a proxy server for the content creator computer.

8. The method according to claim 5, where the selected advertisements are banner ads shown above and below streaming data content.

9. A non-transitory computer-readable recording medium in a web server for providing content-aware ad insertion into streaming data over the Internet, the Internet communicatively interconnects the web server, a content creator computer and a content consumer computer, the non-transitory computer-readable recording medium storing one or more programs which when executed by a web server performs steps comprising:
receiving streaming data from the content creator computer to the web server;
parsing the streaming data to identify keywords within the streaming data;
when the identified keywords are known in a database of keywords associated with available advertisements, selecting the available advertisements corresponding to the identified keywords;
when the identified keywords are unknown in a database of keywords associated with available advertisements, selecting generic advertisements;
inserting the selected advertisements into the streaming data; and
rebroadcasting the modified streaming data to the content consumer computers.

10. The computer-readable recording medium according to claim 9, parsing the streaming data comprises parsing the audio portion of the streaming data and the video portion of the streaming data to identify known keywords.

11. The computer-readable recording medium according to claim 9, wherein rebroadcasting the modified streaming data has the web server acting as a proxy server for the content creator computer.

12. The computer-readable recording medium according to claim 9, where the selected advertisements are banner ads shown above and below streaming data content.
